(19) United States
(12) Patent Application Publication
(10) Pub. No.: US 2011/0075092 A1
(43) Pub. Date: Mar. 31, 2011

(54) Protective Eyewear for Welding and Methods of Use

(76) Inventor: Kurt Nordyke, Wetmore, CO (US)

(21) Appl. No.: 12/566,816

(22) Filed: Sep. 25, 2009

(51) Int. Cl. G02C 7/10; G02C 7/12

(52) U.S. Cl. 351/45; 351/44; 351/49

(57) ABSTRACT

Protective eyewear for Oxy-fuel welding and/or cutting, such as Oxy-acetylene welding and/or cutting is described. The protective eyewear comprises a frame and at least one lens assembly. The at least one lens assembly includes (i) a first portion having translucent properties and (ii) a second portion having translucent properties, the first portion being darker than the second portion. The first portion of the at least one lens assembly is typically of a dark shade to provide protection from potentially harmful light emitted during Oxy-fuel welding and/or cutting process and the second portion of the at least one lens assembly is typically clear allowing a wearer to perform various actions where greater visibility is required. Methods of using the protective eyewear to more efficiently and effectively perform Oxy-fuel welding and/or cutting are disclosed.

### FIELD OF THE INVENTION

The present invention pertains to protective eyewear. More particularly, the present invention pertains to protective eyewear for use when welding.

### BACKGROUND

Protective eyewear is necessary when welding both to protect from particulate matter and harmful light. The type and amount of protection for the eyes, however, varies depending on the type of welding being performed by a person. For instance, arc welding requires considerable protection of the eyes from ultraviolet (UV) light. The intense brightness of the weld area can burn the retinas of a person's eyes requiring very dark lenses for protection. Hence, helmets goggles, sunglasses, and various protective eyewears that may be sufficient for other types of welding may not be sufficient for during arc welding.

In contrast, oxy-fuel welding typically produces significantly less UV light and therefore presents less of a risk of burning the retinas of a person's eyes. Commonly, acetylene is used as the fuel gas used in oxy-fuel welding. However, other types of fuel gases may be used such as, but not limited to, hydrogen, propane, propylene, MAPP gas. For instance, although proper safety from sparks of hot metal and protection from UV light is important at all times, protection from UV light is not as paramount when performing oxy-acetylene welding, particularly when engaging in brazing and light cutting, as it is when arc welding.

Moreover, when performing oxy-fuel welding, it is necessary to read blueprints and/or design instruction as well as quickly observe various activities just prior to and/or after the actual welding task being performed. Hence, it is advantageous to view objects without the looking through the dark lenses while engaged in the various tasks associated with oxy-fuel welding. Removing one's dark lens protective eyewear during such tasks is a potential solution during times when not actively welding. However, a person welding usually always has his or her hands occupied with at least one of a torch, a filler rod, and/or the object being welded. Therefore, quickly putting down a flaming (or still hot) torch or any other object to remove one's dark lens protective eyewear is impractical to quickly glance at blueprints or observe the welded object or molten pool thereon. Additionally, it is not uncommon for a small fire to result from the flaming or heated particulate matter discharged during the welding process that is unnoticeable through dark lenses designed to protect the eyes from intense harmful light.

Dark flip lenses that completely cover clear protective eyewear provide a slight improvement to allowing a quick, clear view during welding. However, such a solution while better than removing one's protective eyewear completely still requires that a person use his or her hands in order to view objects though the clear lens. Further, self-darkening lenses incorporated into protective eyewear also provides slight improvement to allowing a quick, clear view during welding. However, self darkening lenses for use with welding typically have an initial dark shade with which it is difficult to read as well a substantial delay between the auto-darkening and auto-lightening of the lenses. Heretofore, protective eyewear the enables the wearer to instantaneously view objects just prior to and/or after performing welds or cuts remains a desirable tool while engaged in oxy-fuel welding activities.

### BRIEF DESCRIPTION OF THE DRAWINGS

FIG. 1 is a perspective view of a lens assembly utilized in protective eyewear according to an embodiment.

FIG. 2 is a front perspective view of protective eyewear with a plurality of lens assemblies according to a first embodiment.

FIG. 3 is a side perspective view of protective eyewear with a plurality of lens assemblies according to a first embodiment.

FIG. 4 is an overhead perspective view of protective eyewear with a plurality of lens assemblies according to a first embodiment.

FIG. 5 is a rear perspective view of protective eyewear with a plurality of lens assemblies according to a first embodiment.

FIG. 6 is a perspective view of protective eyewear with a single lens assembly according to a second embodiment.

FIG. 7 is a perspective view of a person wearing protective eyewear while actively welding according to an embodiment.

FIG. 8 is a perspective view of a person wearing protective eyewear while reading a document according to an embodiment.

FIG. 9 is a flow chart illustrating a method of using protective eyewear while welding or cutting.

### DETAILED DESCRIPTION

Embodiments of the present invention comprise protective eyewear for use while performing Oxy-fuel welding and/or cutting. At least one lens assembly is included in embodiments of the protective eyewear. The lens assembly comprises a first portion and a second portion. The first portion is darker than the second portion and typically comprises a color and shade for the particular Oxy-fuel welding and/or cutting application. For instance, in one embodiment, the first portion is green with a shade number 2 for use with light-duty Oxy-acetylene welding and cutting. The second portion of the lens assembly is a lighter color and shade as compared to the first portion. Typically, the second portion is clear thereby enabling a wearer to easily observe items and read documents without removing or touching the protective eyewear.

As compared to other types of welding and cutting, Oxy-fuel welding and cutting (and particularly Oxy-acetylene welding and cutting) does not emit as much harmful light and the harmful light emitted is relatively localized. Hence, embodiments of the protective eyewear are designed to provide sufficient protection from the harmful light emitted within the first portion of the lens and provide enhanced visibility for other activities through a clear or lighter second portion of the lens assembly.

The primary components of a typical embodiment comprise a frame, and at least one lens assembly. An exemplary embodiment of the protective eyewear comprises a frame, a left lens assembly, a right lens assembly, a right side guard member, a left side guard member, a right bow piece, and a left bow piece. The frame of the protective eyewear typically includes a bridge, a right lens mount, and a left lens mount. The bridge essentially connects the right lens mount and the left lens mount. The right lens mount is adapted to secure the right lens assembly and the left lens mount is adapted to secure the left lens assembly. The frame is typically comprised of a polymeric material, however, other materials and combinations thereof are contemplated. Moreover, the right and left side guard members are typically, but not necessarily, comprised of the same material, color, and shade as the right first portion and the left first portion of the right and left lens assemblies.

Methods of using embodiments of the protective eyewear enable the wearer to more effectively perform a variety of functions with his or her eyes while engaged in Oxy-fuel welding and/or cutting activities. After providing protective eyewear incorporating at least one lens assembly, the wearer looks through the first portion of the at least one lens assembly while performing Oxy-fuel welding or cutting. For example, the wearer looks through the first portion of the at least one lens assembly while welding an article to object for increased protection from harmful light emitted during the Oxy-acetylene welding process. Next, according to one method, the wearer looks through the second portion of the at least one lens assembly for greater visibility while moving about or otherwise not actively in the process of Oxy-fuel welding or cutting or looking directly at the harmful light emitted by the weld. Moreover, the wearer can additionally look through the second portions of the at least one lens assembly while reading a document.

Benefits of at least some embodiments of the invention include increased effectiveness and safety. Advantageously, the wearer can quickly glance through the second portion of the lens assembly and easily read instructions and/or ascertain whether a fire, excessive pool, or other concern has occurred. To account for a plurality of Oxy-fuel welding and cutting applications, variations in the composition frame and securing means of the protective eyewear and the size, shape, thickness, color, and shade of the at least on lens assembly incorporated therein are included in various embodiments. In sum, the protective eyewear provides the wearer with sufficient protection from harmful light, sparks, and shrapnel while welding and cutting with Oxy-fuels, but has the added benefit of increased efficiency of greater visibility without removing or even touching the protective eyewear enabled by the clear or lighter second portion.

### Terminology

The terms and phrases as indicated in quotes (“ ”) in this section are intended to have the meaning ascribed to them in this Terminology section applied to them throughout this document including the claims unless clearly indicated otherwise in context. Further, as applicable, the stated definitions are to apply, regardless of the word or phrase's case, to the singular and plural variations of the defined word or phrase.

The term “or” as used in this specification and the appended claims is not meant to be exclusive rather the term is inclusive meaning: either or both.

References in the specification to “one embodiment”, “an embodiment”, “an alternative embodiment” and similar phrases mean that a particular feature, structure, or characteristic described in connection with the embodiment is included in at least an embodiment of the invention. The appearances of the phrase “in one embodiment” in various places in the specification are not necessarily all meant to refer to the same embodiment.

The term “couple” or “coupled” as used in this specification and the appended claims refers to either an indirect or direct connection between the identified elements, components or objects. Often the manner of the coupling will be related specifically to the manner in which the two coupled elements interact.

Directional and/or relationary terms such as, but not limited to, “left”, “right”, “top”, “bottom”, “vertical”, “horizontal”, “back”, “front” and “lateral” are relative to each other and are dependent on the specific orientation of an applicable element or article, and are used accordingly to aid in the description of the various embodiments and are not necessarily intended to be construed as limiting.

As applicable, the terms “about” and “generally” as used herein unless otherwise indicated mean a margin of +−20%. Also, as applicable, the term “substantially” as used herein unless otherwise indicated means a margin of +−10%. Concerning angular measurements, “about” or “generally” refer to +−10 degrees and “substantially” refers to +−5.0 degrees unless otherwise indicated. It is to be appreciated that not all uses of the above terms are quantifiable such that the referenced ranges can be applied.

The phases “Oxy-fuel welding” and/or “Oxy-fuel cutting” as used in this specification and the appended claims refers to any welding-related activity including, but not limited to, welding, torch cutting, and brazing where oxygen and fuel are used together to produce a high temperature flame for use therewith. Fuels used in conjunction with oxygen include, but are not limited to, acetylene, hydrogen, propane, propylene, and MAPP gas.

The phases “Oxy-acetylene welding” and/or “Oxy-acetylene cutting” as used in this specification and the appended claims refers to Oxy-fuel welding and/or cutting where the fuel used in conjunction with oxygen is acetylene.

The term “harmful light” as used in this specification and the appended claims refers to wavelengths of electromagnetic radiation comprising one or more of visible light, infrared light, and ultraviolet (UV) light. Depending on the intensity and composition of the harmful light in a specific application, the harmful light may or may not actually cause harm a person's eyes.

The term “shade number” as used in this specification and the appended claims refers to the commonly-used designation in the United States of America indicating different degrees of “darkness” of a protective lens applicable for various welding-related activities to protect a wearer's eyes from intense visible light. Shade numbers typically range from 1 to 14 and are typically calculated by the following formula: Shade number=((7*(−log₁₀ T))/3)+1, where T is the transmission or the fraction of visible light transmitted though the protective lens. Generally, the higher the shade number, the greater the protection from visible light provided by the protective lens.

### One Embodiment of a Lens Assembly for Use in Protective Eyewear

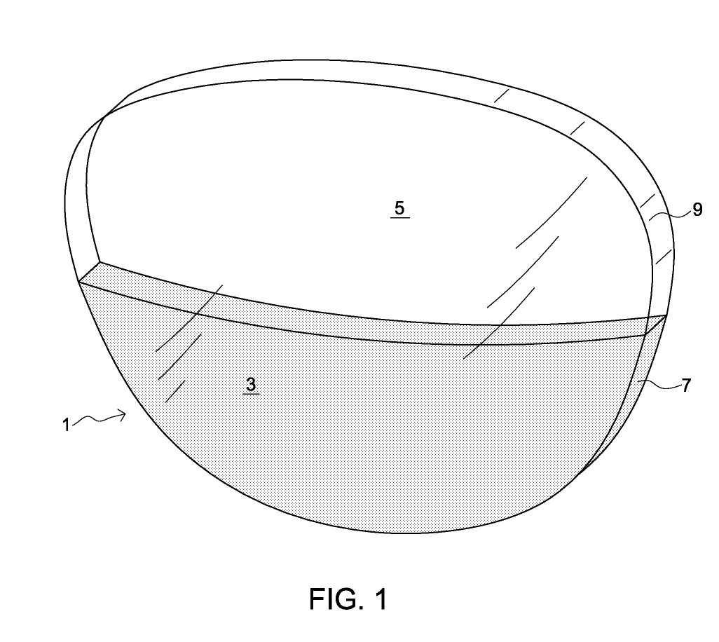

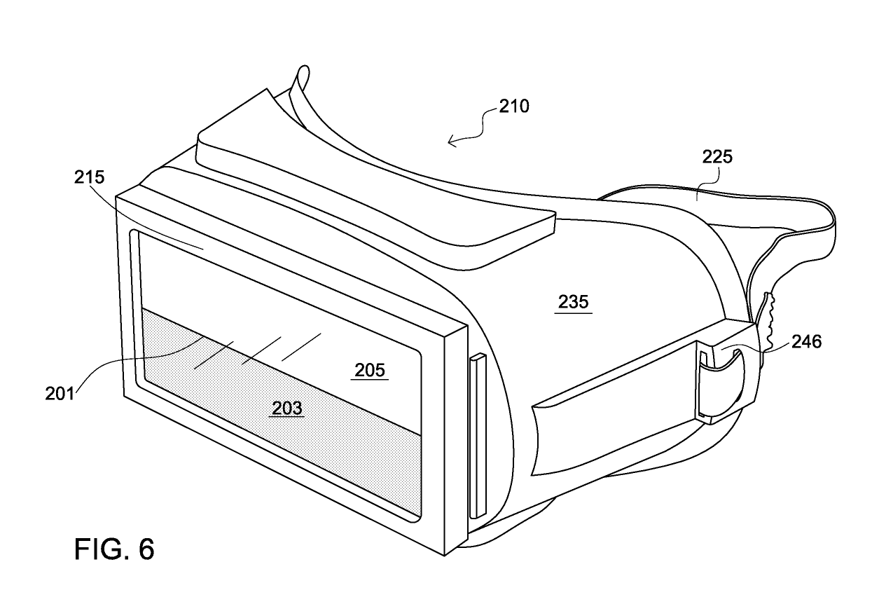

FIG. 1 is an illustration of a lens assembly 1 that is used in protective eyewear. The protective eyewear including lens assembly 1 is typically used in oxy-fuel welding and cutting, particularly oxy-acetylene welding and cutting. Lens assembly 1 comprises a first portion 3 and a second portion 5 of generally translucent nature. A first portion edge 7 surrounds the first portion 3 of lens assembly 1 and a second portion edge 9 surrounds the second portion 5 of lens assembly 1. In embodiments of protective eyewear, lens assembly 1 is typically of a generally oval and curved shape similar to many types of lenses for sunglasses and corrective eyewear. However, lens assembly is flat and rectangular in other embodiments (see FIG. 6) and may be any one of a plurality of shapes such as, but not limited to, flat circular, curved circular, curved rectangular, and curved elongated ovoid (covering both of a wearer's eyes).

Importantly, the first portion 3 is darker than the second portion 5. Both the first and second portion 3 & 5 are comprised of a polycarbonate material having a thickness of approximately 2.286 millimeters at the first and second portion edges 7 & 9 and throughout the entire lens assembly 1. However, typical embodiments generally have a thickness anywhere from approximately 2 millimeters to approximately 3.5 millimeters and are comprised of a variety of polymeric material or compounds. Additionally, the first portion 3 is green in color with a shade number 2. Green is a typical color for the first portion 3 when the lens assembly 1 is used in conjunction with the Oxy-acetylene welding and cutting. However, other colors such as, but not limited, amber, blue, and grey can be used in embodiments. Moreover, other shades such as, but not limited to, shade number 1, shade number 3, shade number 4, and shade number 5 can be used in embodiments in conjunction with any color. The second portion 5 of lens assembly 1 is clear. However, variations of the second portion need not be clear, but rather may be any color and shade number as long as the result is lighter than the first portion. For instance, in some variations lens assembly can comprise a first portion of dark amber color and shade number 5 and a second portion of light amber color and shade number 1.

Although not limiting to alternative embodiments, preferably the surface area of the first portion 3 is approximately 50% or more of the total surface area of the lens assembly to provide more protection to the eyes of the wearer while in the process of Oxy-fuel welding or cutting. Additionally, the lens assembly 1 can be comprised of various materials such as but not limited to, a variety of polymers, plastics, and glass materials. Moreover, the first portion 3 can be comprised of a first material and the second portion 5 may be comprised of a second material. For example, a variation of the lens assembly can include the first portion comprising a plastic material and the second portion comprising a hardened glass material.

It is important to note that the first portion 3 is typically of a substantially uniform color throughout that portion of the lens assembly 1. Likewise, the second portion 5 is typically of a substantially uniform color throughout that portion, clear in one embodiment. Hence, a relatively stark contrast in color and shade is created the between the first and second portions 3 & 5. Embodiments providing this stark contrast between the first and second portions 3 & 5 provide a benefit to the wearer of unambiguously being cognizant of the portion of the lens assembly and the level of protection from harmful light emitting therethrough. This lens configuration is distinct from a lens which provides a gradual change in the color and shade as found in some types of sunglasses. When a lens is utilized in protective eyewear for use while oxy-fuel welding and brazing, a gradual change in the color and shade of a lens can be detrimental in some instances. For example, the eyes may be exposed to excessive harmful light for a prolonged period of time if the person looking through a section of the lens that does not provide sufficient color and shade protection for activity being performed whereas the wearer looking through some lesser color and shade believes it does. Hence, the stark contrast between the first and second portions 3 & 5 of the lens assembly 1 and similar contrasts incorporated into embodiments of the present invention provide an important function for the use of the lens assembly while oxy-fuel welding and brazing.

Still referring to FIG. 1, the lens assembly 1 is generally oval with a top to bottom distance (vertical length) of approximately 1.63 inches. The distance from right to the left distance (horizontal length) is approximately 1.90 inches. The distances identified for the lens assembly 1 are measured from the longest point along their respective vertical and horizontal axis relative to the first and second portion edges 7 & 9. However, many lens assembly sizes are contemplated depending on the various embodiments of the invention. Moreover, a polarized substrate may be added to the lens assembly 1 typically on a front face or a rear face.

It is pertinent to note that the lens assembly is not limited to limited to any one size, shape, thickness, color or shade. However, the first portion of the lens assembly is required to be darker than the first portion of the lens assembly in all variations and embodiments.

### A First Embodiment of Protective Eyewear Incorporating a Plurality of Lens Assemblies

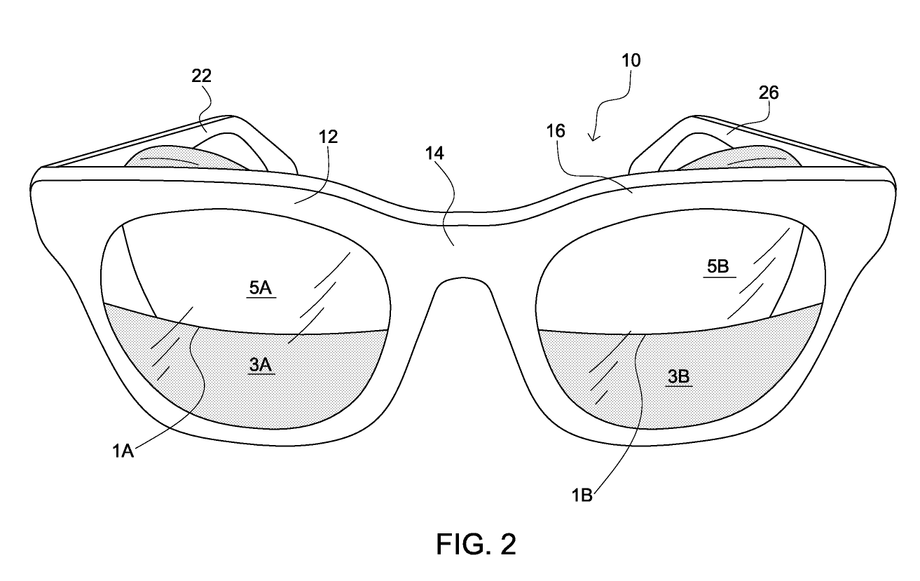

FIG. 2 is a front perspective view of protective eyewear incorporating a plurality of lens assemblies according to a first embodiment. Protective eyewear 10 comprises a right lens assembly 1a and a left lens assembly 1b (from the perspective of a wearer). The right lens assembly 1a comprises a right first portion 3a and a right second portion 5a. Similarly, the left lens assembly 1b comprises a left first portion 3b and a left second portion 5b.

A frame of the protective eyewear 10 includes a bridge 14, a right lens mount 12, and a left lens mount 16. The bridge 14 connects the right lens mount 12 and the left lens mount 16. The right lens mount 12 is adapted to secure the right lens assembly 1a and the left lens mount 16 is adapted to secure the left lens assembly 1b. The frame can be comprised of polymeric material or any other materials or combinations thereof. Further, the protective eyewear 10 includes a right bow piece 22 and a left bow piece 26 that are pivotally mounted to the frame.

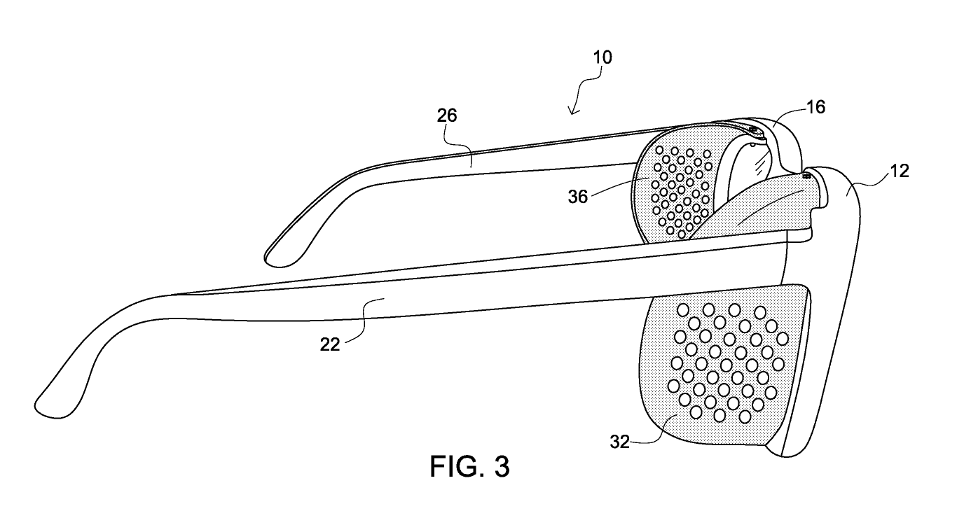

As illustrated in FIG. 3, the protective eyewear 10 also includes a right side guard member 32 and a left side guard member 36. The right and left side guard members 32 & 36 are typically, but not necessarily, comprised of the same material, color, and shade as the right first portion 3a and the left first portion 3b (as shown in the perspective views of FIGS. 1 & 2). Moreover, the right and left side guard members 32 & 36 typically include a plurality of small bores to aid in ventilation. When extended while using the protective eyewear 10, an edge portion of the right side guard member 32 extends along a back surface of the right lens mount 12 in a generally circumferential and arcuate fashion. Similarly, an edge portion of the left side guard member 36 extends along a back surface of the left lens mount 16 in a generally circumferential and arcuate fashion. Additionally, side sections of the right and left side guard members 32 & 36 run generally perpendicular to the right and left bow pieces 22 & 26, respectively.

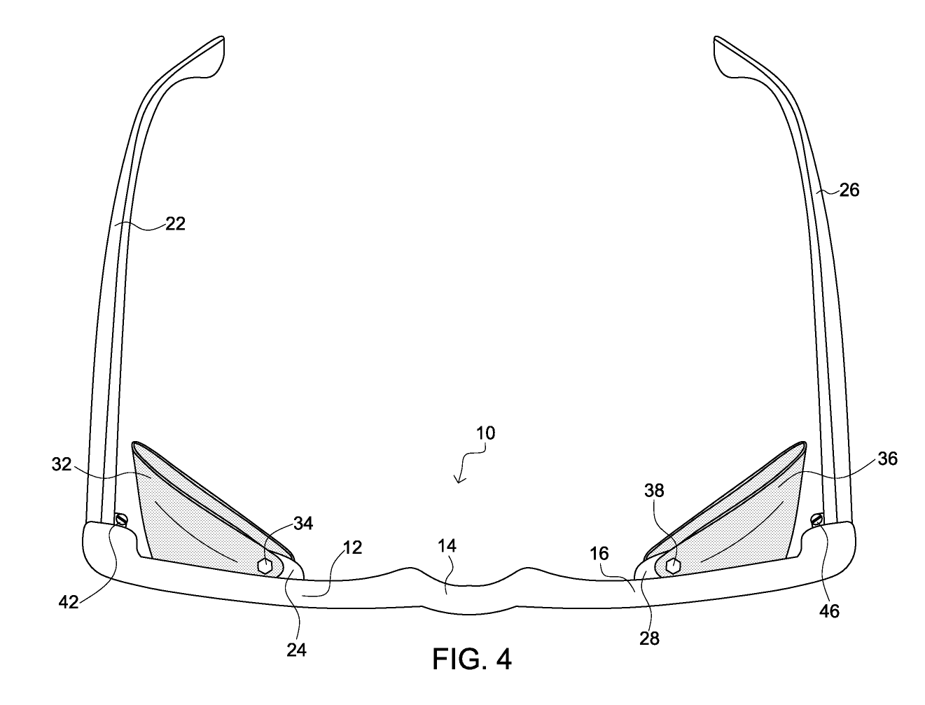

FIG. 4 is an overhead perspective view of protective eyewear 10. A right mount hinging pin 42 pivotally couples the right bow piece 22 to the right lens mount 12 and a left mount hinging pin 46 pivotally couples the left bow piece 26 to the left lens mount 16. Additionally, a right flange 24 is integrated with the right lens mount 12. Similarly, a left flange 28 is integrated with the left lens mount 16. Also shown in FIG. 4 are a top right side guard hinging pin 34 and a top left side guard hinging pin 38 connecting the right and left side guards 32 & 36 to the right and left flange 24 & 28, respectively.

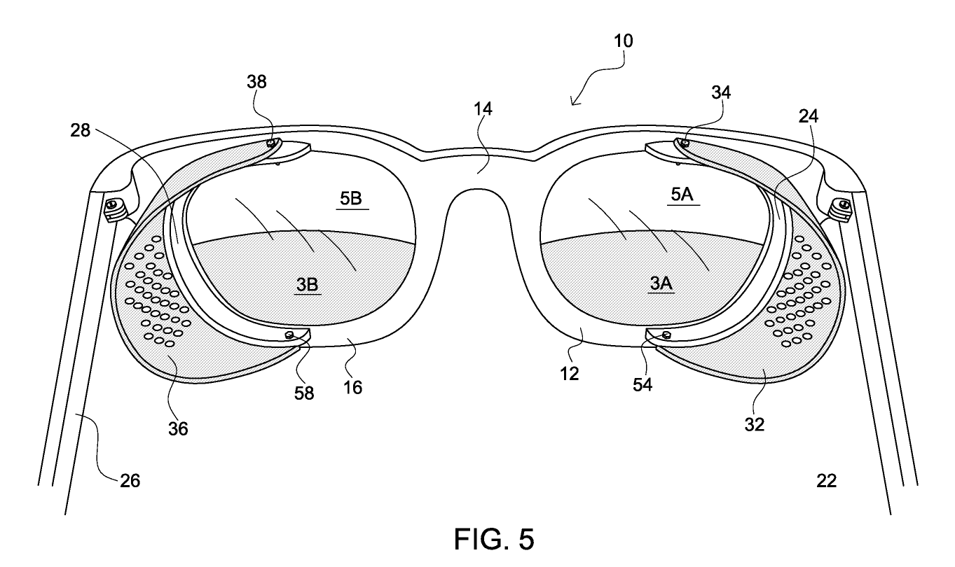

As can best be seen from the rear perspective view of FIG. 5, the right flange 24 provides support for the right side guard member 32 and the left flange 28 provides support for the left side guard member 36. Additionally, a bottom right side guard hinging pin 54 and a bottom left side guard hinging pin 58 connect the right and left side guards 32 & 36 to the right and left flange 24 & 28, respectively. The top and bottom right side guard hinging pins 34 & 54 extend through bores in the right side guard member 32 and the right flange 24 thereby enabling the right side guard member 32 to be pivotably coupled to the right lens mount 12 and right flange 24 thereof. The top and bottom left side guard hinging pins 38 & 58 extend through bores in the left side guard member 36 and left flange 28 thereby enabling the left side guard member 36 to be pivotally coupled to the left lens mount 16 and left flange 28 thereof.

Still referring to FIG. 5, while using the protective eyewear 10, friction between surfaces of the right side guard member 32 and the right flange 24 enables the right side guard member 32 to be fixably coupled in addition to being pivotably coupled to the right lens mount 12 and right flange 24 thereof. Similarly, friction between surfaces of the left side guard member 36 and the left flange 28 enables the left side guard member 36 to be fixably coupled in addition to being pivotably coupled to the left lens mount 16. It is to be appreciated that right and left side guard members can be fixably and/or pivotably coupled by a range of implementations in variations and other embodiments and not limited to the implementation described above.

When storing the protective eyewear 10, the right and left side guards 32 & 36 can be pivoted whereby their respective side edge portions will converge proximal the bridge 14 of the frame. Similarly, the right and left bow pieces 22 & 26 can pivot or fold generally along the frame of the protective eyewear 10 while not in use.

### A Second Embodiment of Protective Eyewear Incorporating the Lens Assembly

Turning now to FIG. 6, protective eyewear incorporating a lens assembly according to a second embodiment is illustrated. Protective eyewear in the form of goggles 210 comprises a generally flat and rectangular lens assembly 201. The rectangular lens assembly 210 comprises a first portion 203 and a second portion 205, both portions being generally rectangular. The rectangular lens assembly 201 has a vertical length of approximately 1.75 inches and a horizontal length of approximately 5.50 inches. It is to be appreciated that rectangular lens assembly 201 is a variation of the lens assembly 1 illustrated in FIG. 1 and described in detail above whereas the rectangular lens assembly 201 is capable of the further variations and subject to the limitations described with respect to lens assembly 1.

A lens mount 215 of the goggles 210 is adapted to secure the rectangular lens assembly 210. The lens mount is typically integrated into a frame 235. The frame 235 in the second embodiment of protective eyewear incorporates, among other things, integrated right and left side guard members that do not allow light to pass through, but nonetheless provide protection from sparks of hot metal and other shrapnel. Further, the goggles 210 comprise a strap 225 and clips 246 adapted to secure the goggles 210 to the wearer's head. Typically, but not necessarily, the clips 246 may be integrated into frame 235. A left side (from the wearer's perspective) clip 246 is shown with its openings designed to allow the strap 225 to be fixably movable therethrough. A complementary right side clip (not show) provides an opposing movable anchoring point for the strap 225. Various other means to secure the goggles 210 to the wearer's head are contemplated including, but not limited to, a plurality of straps anchored to the frame and an integrated helmet portion with securing straps therein.

It is pertinent to note that although embodiments of the same inventive concept, the second embodiment of protective eyewear is better suited for use during Oxy-fuel welding and/or cutting when a substantial amount of shrapnel is expected to be emitted during the process.

### An Exemplary Method of Using Embodiments of the Protective Eyewear

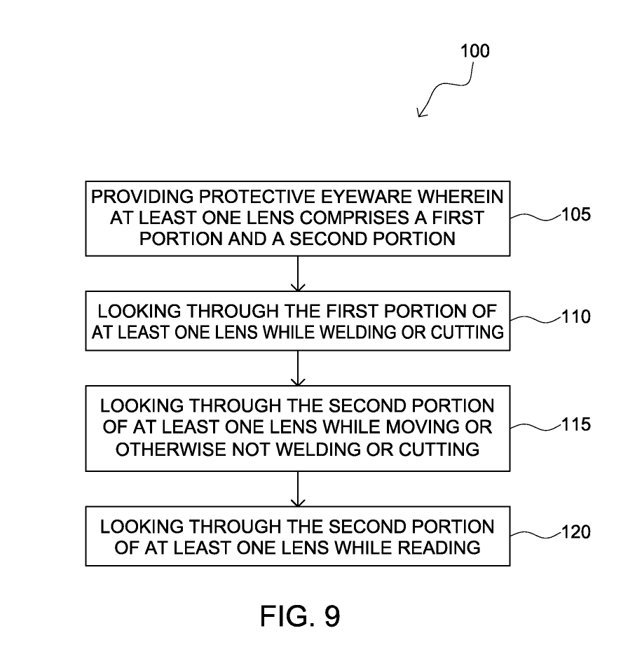

Embodiments of the protective eyewear incorporating the lens assembly as described above are typically utilized in Oxy-fuel welding and/or cutting. Utilizing embodiments of the protective eyewear incorporating the lens assembly are particularly applicable to Oxy-acetylene welding and/or cutting given the lower levels of harmful light emitted. An exemplary method utilizing embodiments of the protective eyewear incorporating the lens assembly is illustrated in the flow chart of FIG. 9.

Method 100 enables a person to more effectively perform a variety of functions with his or her eyes such as, but not limited to observing and reading, while engaged in Oxy-fuel welding and/or cutting activities. An operation 105 of method 100 comprises providing protective eyewear incorporating at least one lens assembly. As illustrated in FIG. 1 and described herein, each of the at least one lens assembly 1 comprises a first portion 3 and a second portion 5 wherein the first portion is darker than the second portion. For example, a person can be provided with and wear (a wearer) the first embodiment protective eyewear 10 comprising two lens assemblies, the right and left lens assemblies 1a & 1b, as illustrated in FIGS. 2 through 5 and described herein. However, the second embodiment protective eyewear 210 (FIG. 6) or other alternative embodiments and variations can be provided in operation 105.

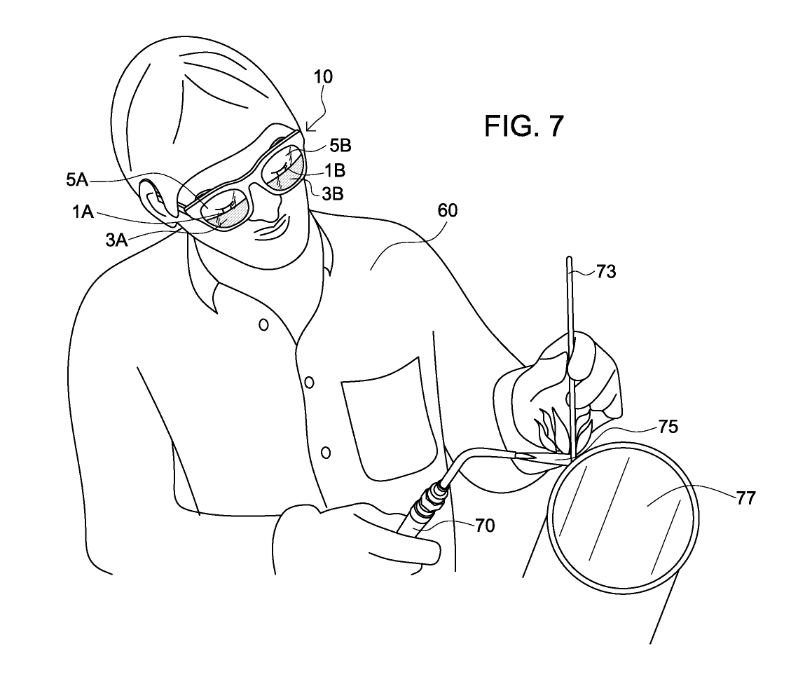

Next, the wearer looks through the first portion of at least one lens assembly while performing Oxy-fuel welding or cutting (operation 110). Referring now to FIG. 7, wearer 60 with protective eyewear 10 is shown actively welding. The wearer 60 is looking through the first portions 3a & 3b of the right and left lens assemblies 1a & 1b of the protective eyewear 10 while welding an article to object 77. The wearer 60 is holding an Oxy-fuel torch 70 in his right hand and a welding rod 73 in his left hand. Flames 75 from the Oxy-fuel torch 70 and reaction with the welding rod 73, article, and object 77 result in harmful light emission from which the wearer 60 is protected when looking through the first portions 3a & 3b. It is to be appreciated that while the second portions 5a & 5b of the right and left lens assemblies 1a & 1b may not provide protection from intense harmful light in embodiments where they are substantially clear, the second portions 5a & 5b do provide protection for the wearer's eyes from shrapnel, sparks, and other emissions.

Referring back to FIG. 9, the wearer looks through the second portions of the at least one lens assembly while moving about or otherwise not actively in the process of Oxy-fuel welding or cutting (operation 115). For example, the wearer 60 may place the Oxy-fuel torch 70 and the welding rod 73 (illustrated in FIG. 7) down temporarily to move about the area. Hence, the wearer need not remove his protective eyewear 10, but rather move about while looking through the second portions 5a & 5b of the right and left lens assemblies 1a & 1b.

More efficient and effective Oxy-fuel welding and cutting is achieved while using the protective eyewear incorporation at least one lens assembly according to method 100. For example, the wearer 60 can quickly observe a molten pool formed by the welding rod 73 by momentarily turning off the Oxy-fuel torch 70 or moving it out of the wearer's line of site and looking through the second portions 5a & 5b of the right and left lens assemblies 1a & 1b to determine if the molten pool is of the proper size and location for the required weld on the object 77 before it hardens and become difficult if not impossible to remedy (reference the illustration of FIG. 9). Also, tools or items accidentally dropped during the process of Oxy-fuel welding and cutting can be easily found and retrieved by looking though the second portions 5a & 5b without having to remove one's protective eyewear. Additionally, safety aspects of the protective eyewear incorporating at least one lens assembly are exemplified in method 100. For instance, a small fire undetectable while looking through dark only protective lenses may be caused from emitted sparks or shrapnel while welding or cutting. However, frequent checking of the immediate worksite and adjacent areas enabled by peering through the second portions of the at least one lens assembly will quickly alert the wearer to such as fire and allow extinguishing prior to any significant damage.

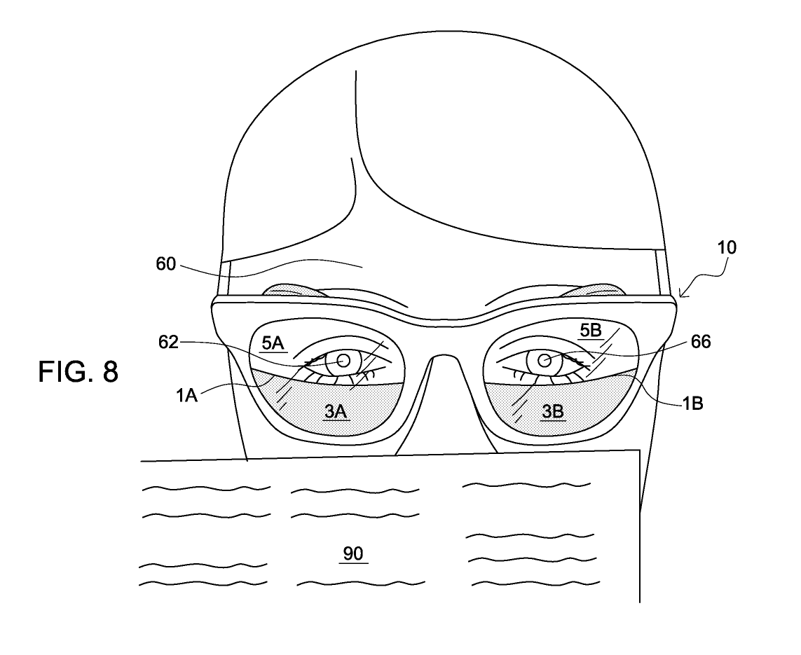

Next, as illustrated in FIG. 9, the wearer can additionally look through the second portions of the at least one lens assembly while reading (operation 120). As illustrated in FIG. 8, the wearer 60 is reading a document 90 while wearing protective eyewear 10. The document 90 can be any number of items such as, but not limited to, blueprints, diagrams, plans, and instructions. Wearer's right eye 62 and wearer's left eye 66 are focused on and clearly able to read the document 90 through the second portions 5a & 5b of the right and left lens assemblies 1a & 1b. It is pertinent to note that the document 90 may be on a workbench or other support structure as opposed to in the wearer's hands. Hence, by diverting his eyes and/or slightly moving his head, the wearer 60 can read the document 90 while continuing to hold both the Oxy-fuel torch 70 and the welding rod 73 (as shown in FIG. 7) while actually in the process of welding or just thereafter.

It is to be appreciated that the wearer may perform any number of tasks while not actively in the process of Oxy-fuel welding and/or cutting, either momentarily or for an extended time period. Although a few exemplary tasks are mentioned herein, other tasks are contemplated and their associated benefits are achievable while utilizing the protective eyewear incorporating the at least one lens assembly.

### Other Embodiments and Variations

The various embodiments and variations thereof illustrated in the accompanying figures and/or described above are merely exemplary and are not meant to limit the scope of the invention. It is to be appreciated that numerous variations to the invention have been contemplated as would be obvious to one of ordinary skill in the art with the benefit of this disclosure. All variations of the invention that read upon the appended claims are intended and contemplated to be within the scope of the invention.

Orientation of the first portion and second portions of the lens assembly can vary in alternate embodiments. For instance, if a person was performing oxy-fuel welding and cutting on objects generally above one's head, the darker first portion of the lens assembly would be on the upper or top half of the lens assembly. Thickness of the lens assemble can range to over 12.7 millimeters with a shade number 8 or higher in some heavy Oxy-fuel welding and cutting activities. Moreover, embodiments of the lens assembly included variations wherein the lens assembly may fit over, or incorporate prescriptive eyewear.

I claim:

1. A protective eyewear for welding and cutting comprising:
a frame; and
at least one lens assembly,
wherein the frame is coupled to the at least one lens assembly and the at least one lens assembly includes (i) a first portion having translucent properties and (ii) a second portion having translucent properties, the first portion being darker than the second portion.

2. The protective eyewear of claim 1, wherein the first portion is green and the second portion is substantially clear.

3. The protective eyewear of claim 1, wherein the first portion comprises a polymeric material of shade number 2 having a thickness of approximately 2.286 millimeters and the second portion comprises a polymeric material of shade number less than 2 having a thickness of about 2.286 millimeters.

4. The protective eyewear of claim 1, wherein the at least one lens assembly further includes a polarized substrate, the polarized substrate being attached to one of a front face and a rear face of the second portion.

5. The protective eyewear of claim 5, wherein the polarized substrate is further attached to one of a front face and a rear face of the first lens portion

6. The protective eyewear of claim 1, wherein the at least one lens assembly is generally oval and has a vertical length of approximately 1.63 inches and a horizontal length of approximately 1.90 inches as measured from a longest point along a vertical and horizontal axis.

7. The protective eyewear of claim 1, wherein the at least one lens assembly is generally rectangular and has a vertical length of approximately 1.75 inches and a horizontal length of approximately 5.50 inches.

8. The protective eyewear of claim 1, wherein the first portion of the at least one lens assembly has a uniform first color and the second portion of the lens assembly has a uniform second color.

9. The protective eyewear of claim 1, wherein the at least one lens assembly comprises a right lens assembly and a left lens assembly and the frame comprises a bridge, a right lens mount and a left lens mount.

10. The protective eyewear of claim 9, further including a right side guard member and a left side guard member coupled to the frame, the right and left side guard members being generally arcuate and extending outwardly from and around outer portions of the right and left lens mounts of the frame.

11. The protective eyewear of claim 10, wherein
the right side guard member has a top portion and a lower potion proximal the bridge of the frame and a side edge portion distal the bridge of the frame, the top and bottom portion pivotably coupled to the right lens mount of the frame allowing the side edge portion to rotate toward the bridge of the frame; and
the left side guard member has a top portion and a lower portion proximal the bridge of the frame and a side edge portion distal the bridge of the frame, the top and bottom portion pivotably coupled to the left lens mount of the frame allowing the side edge portion to rotate toward the bridge of the frame.

12. The protective eyewear of claim 10, further including a right bow piece and a left bow piece.

13. A dual lens protective eyewear comprising:
a frame;
a right lens assembly;
a left lens assembly;
a right bow piece; and
a left bow piece;
wherein (i) the frame includes a bridge, a right lens mount, and a left lens mount, the bridge being in the general center of the frame in between the right and left lens mounts, (ii) the right and left lens assemblies each have first portions comprising a colored polycarbonate material and second portions comprising a clear polycarbonate material, (iii) the right and left lens assemblies are coupled to the right and left lens mounts, respectively, and (iv) the right and left bow pieces are each pivotably coupled to the frame at portions of the right and left lens mounts, respectively, distal the bridge.

14. The dual lens protective eyewear of claim 13, further including:
a right side guard member; and
a left side guard member;
wherein (a) the right lens mount further comprises a right flange circumferentially therearound a portion of the right lens mount and the left lens mount further comprises a left flange circumferentially therearound a portion of the left lens mount distal the bridge, and (iv) the right and left side guard members are fixably and pivotably coupled to right and left flanges.

15. A method of protecting and enabling greater use of one's eyes while performing Oxy-fuel welding and cutting, the method comprising:
providing protective eyewear, the protective eyewear comprising (i) a frame, (ii) at least one lens assembly, wherein the frame is coupled to the at least one lens assembly and the at least one lens assembly includes (1) a first portion having translucent properties, and (2) a second portion having translucent properties, the first portion being darker than the second portion;
looking through the first portion of the at least one lens assembly while wearing the protective eyewear and performing one of an Oxy-fuel welding operation and Oxy-fuel cutting operation.

16. The method of claim 15, further including,
looking through the second portion of the at least one lens assembly while wearing the protective eyewear and not actively performing one of an Oxy-fuel welding operation and Oxy-fuel cutting operation.

17. The method of claim 15, further including,
looking through the second portion of the at least one lens assembly while wearing the protective eyewear and moving about.

18. The method of claim 15, further including,
looking through the second portion of the at least one lens assembly while wearing the protective eyewear to check a molten pool created while performing the one of the Oxy-fuel welding operation and Oxy-fuel cutting operation by looking through the second portion of the at least one lens assembly.

19. The method of claim 15, further including,
looking at an item through the second portion of the at least one lens assembly while wearing the protective eyewear and continuing to perform the one of the Oxy-fuel welding operation and Oxy-fuel cutting operation weld without touching the protective eyewear with one's hands.

20. The method of claim 19, wherein the item is a document.
